(19) United States
(12) Patent Application Publication
(10) Pub. No.: US 2017/0004671 A1
(43) Pub. Date: Jan. 5, 2017

(54) Instant Lottery Ticket Vending Machine

(71) Applicants: Blair M. Connolly, Paradise (CA); David P. Connolly, Mt. Pearl (CA)

(72) Inventors: Blair M. Connolly, Paradise (CA); David P. Connolly, Mt. Pearl (CA)

(73) Assignee: BRITISH BAZAAR COMPANY LIMITED, St. John's (CA)

(21) Appl. No.: 14/825,202

(22) Filed: Aug. 13, 2015

(30) Foreign Application Priority Data
Jul. 2, 2015 (CA) 2896237

(51) Int. Cl. G07F 17/32; G07F 11/72; G06K 19/06; G06Q 20/20; G06Q 20/18; G06K 7/10; G07F 17/42; G07F 11/44

(52) U.S. Cl. CPC G07F 17/329; G07F 17/42; G07F 11/72; G07F 11/44; G06Q 20/204; G06Q 20/18; G06Q 20/208; G06K 7/10712; G06K 19/06028

(57) ABSTRACT

A lottery ticket vending machine including a user interface for being operated by a player. The user interface is adapted for enabling user interaction for purchasing a lottery ticket. A controller is connected to the user interface for controlling operation of the lottery ticket vending machine. The lottery ticket vending machine further comprises a ticket storage container for storing loose tickets therein such that the tickets are oriented substantially horizontally and stacked upon each other substantially vertically. The ticket storage container has a holding structure for interacting with a portion of a bottom surface of a ticket placed at a bottom of the stack and a gate for transmitting the ticket therethrough while substantially preventing transmission of a ticket stacked thereupon. A ticket conveyor is connected to the controller for conveying the ticket by interacting with a portion of the bottom surface thereof. A dispensing chute receives the ticket from the ticket conveyor and dispenses the same to the player. A reader connected to the controller, the reader being disposed between the ticket conveyor and the dispensing chute for reading a ticket identifier disposed on the ticket after removal from the ticket storage container and prior provision to the dispensing chute and for providing ticket identification data in dependence thereupon to the controller.

This application claims priority to Canadian Patent Application Serial No. 2,896,237, entitled INSTANT LOTTERY TICKET VENDING MACHINE filed with the Canadian Intellectual Property Office on Jul. 2, 2015.

### FIELD

The present invention relates to instant lottery ticket games, and more particularly to an instant lottery ticket vending machine.

### BACKGROUND

Instant lottery games have become an important source of income to governments and numerous non-for-profit organizations. Typically, a set of instant lottery tickets is imaged with play and prize value indicia under a scratch-off coating or break-open tab according to a predetermined prize structure. The prize structure comprises a small number of large value prize tickets, a number of lesser value prize tickets, and a large number of non-winning tickets. The prizes are distributed randomly to the tickets such that each player has an equal chance to win one of the prizes.

The tickets are then distributed to lottery ticket retailers—such as, for example, liquor stores, convenience stores, supermarkets, gas stations, gift shops, etc.—for dispensing the tickets to consumers and for validating the tickets when they are presented for redemption. Typically, the tickets are dispensed in lottery kiosks which are attended by an employee of the lottery retailer, thus limiting dispensing of the tickets to the opening hours of the lottery ticket retailer.

With numerous lottery games on the market it has become a challenge to sustain public interest and, therefore, numerous different instant lottery games, in some cases with varying prizes such as jackpots, are offered to the potential player.

Automation has come a long way enabling dispensing of numerous different items in vending machines. However, there is still a need for a vending machine that is capable of dispensing instant lottery tickets of different lottery games in a reliable and secure fashion.

### SUMMARY

Accordingly, one object of the present invention is to provide an instant lottery ticket vending machine that is capable of dispensing instant lottery tickets in a reliable fashion.

Another object of the present invention is to provide an instant lottery ticket vending machine that is capable of dispensing instant lottery tickets of different lottery games in a reliable fashion.

Another object of the present invention is to provide an instant lottery ticket vending machine that is capable of dispensing instant lottery tickets in a secure fashion.

According to one aspect of the present invention, there is provided a lottery ticket vending machine. The lottery ticket vending machine comprises a user interface for being operated by a player. The user interface is adapted for enabling user interaction for purchasing a lottery ticket.

A controller is connected to the user interface for controlling operation of the lottery ticket vending machine. The lottery ticket vending machine further comprises a ticket storage container for storing loose tickets therein such that the tickets are oriented substantially horizontally and stacked upon each other substantially vertically. The ticket storage container has a holding structure for interacting with a portion of a bottom surface of a ticket placed at a bottom of the stack and a gate for transmitting the ticket therethrough while substantially preventing transmission of a ticket stacked thereupon. A ticket conveyor is connected to the controller for conveying the ticket by interacting with a portion of the bottom surface thereof

A dispensing chute receives the ticket from the ticket conveyor and dispenses the same to the player. A reader connected to the controller, the reader being disposed between the ticket conveyor and the dispensing chute for reading a ticket identifier disposed on the ticket after removal from the ticket storage container and prior provision to the dispensing chute and for providing ticket identification data in dependence thereupon to the controller.

According to an aspect of the present invention, there is provided a ticket dispenser. The ticket dispenser comprises a ticket storage container for storing loose tickets therein such that the tickets are oriented substantially horizontally and stacked upon each other substantially vertically. The ticket storage container has a holding structure for interacting with a portion of a bottom surface of a bottom ticket and a gate for transmitting the bottom ticket therethrough while substantially preventing transmission of a ticket stacked upon the bottom ticket. The ticket dispenser further comprises a ticket conveyor for conveying the bottom ticket by interacting with a portion of the bottom surface thereof and a controller connected to the ticket conveyor for controlling operation of the ticket conveyor such that the tickets are successively transmitted.

According to an aspect of the present invention, there is provided a ticket dispenser. The ticket dispenser comprises a ticket storage container for storing loose tickets therein such that the tickets are oriented substantially horizontally and stacked upon each other substantially vertically. The ticket storage container has a holding structure for interacting with a portion of a bottom surface of a bottom ticket and a gate for transmitting the bottom ticket therethrough while substantially preventing transmission of a ticket stacked upon the bottom ticket. The ticket dispenser further comprises a ticket conveyor for conveying the bottom ticket by interacting with a portion of the bottom surface thereof and a controller connected to the ticket conveyor for controlling operation of the ticket conveyor such that the tickets are successively transmitted. The ticket conveyor comprises a conveying belt rotatable about a first and a second pulley. The second pulley is rotatable mounted to a conveyor arm with the conveyor arm being pivotable movable mounted about an axis of rotation of the first pulley. An actuator connected to the conveyor arm and the controller moves the conveyor arm between an up position and a down position. In the up position a portion of the conveying belt is interacting with the portion of the bottom surface of the bottom ticket. A substantially vertically movable sensing wheel has an axis of rotation oriented substantially parallel to an axis of rotation of the first pulley. The sensing wheel is linearly movable mounted such that its axis of rotation is linearly movable in a substantially vertical oriented plane through the axis of rotation of the first pulley. A sensor senses the vertical movement of the sensing wheel and provides a signal indicative of: no ticket; one ticket; or, more than one ticket.

One advantage of the present invention is that it provides an instant lottery ticket vending machine that is capable of dispensing instant lottery tickets in a reliable fashion.

A further advantage of the present invention is that it provides an instant lottery ticket vending machine that is capable of dispensing instant lottery tickets of different lottery games in a reliable fashion.

A further advantage of the present invention is that it provides an instant lottery ticket vending machine that is capable of dispensing instant lottery tickets in a secure fashion.

### BRIEF DESCRIPTION OF THE DRAWINGS

An embodiment of the present invention is described below with reference to the accompanying drawings, in which:

FIGS. 1a to 1d are simplified block diagrams illustrating a front view, a perspective top view, a perspective front view, and an exploded view, respectively, of an instant lottery ticket vending machine according to one embodiment of the invention;

FIGS. 1e and 1f are simplified block diagrams illustrating a lottery ticket for use with the instant lottery ticket dispensing device according to one embodiment of the invention;

FIGS. 1g to 1i are simplified block diagrams illustrating in perspective front views three steps of accessing a ticket storage unit of the instant lottery ticket vending machine illustrated in FIGS. 1a to 1d;

FIGS. 2a to 2c are simplified block diagrams illustrating a perspective top view, a detail, and a perspective bottom view, respectively, of a ticket storage unit of the instant lottery ticket vending machine illustrated in FIGS. 1a to 1d;

FIGS. 2d to 2f are simplified block diagrams illustrating a top view, a cross sectional view, and a front view of a ticket storage compartment of the ticket storage unit illustrated in FIGS. 2a to 2c;

FIG. 2g is a simplified block diagram illustrating a perspective view of a curved break-open lottery ticket;

FIG. 3a is a simplified block diagram illustrating a cross sectional view of a portion of the ticket storage unit illustrated in FIGS. 2a to 2c in conjunction with ticket dispenser of the instant lottery ticket vending machine illustrated in FIGS. 1a to 1d;

FIGS. 3b and 3c are simplified block diagrams illustrating a cross sectional view of the ticket dispenser illustrated in FIG. 3a with the conveyor arm in the down position and in the up position, respectively;

FIG. 3d is a simplified block diagram illustrating a cross sectional perspective view of the ticket dispenser illustrated in FIG. 3a;

FIGS. 3e and 3f are simplified block diagrams illustrating a perspective view of the ticket dispenser illustrated in FIG. 3a in conjunction with the ticket storage unit and without, respectively;

FIG. 3g is a simplified block diagram illustrating a top view of the ticket dispenser illustrated in FIG. 3a;

FIG. 3h is a simplified block diagram illustrating a cross sectional view of the ticket dispenser illustrated in FIG. 3a with a ticket being conveyed; and

FIG. 4 is a simplified block diagram illustrating a cross sectional view of the ticket dispenser illustrated in FIG. 3a with a barcode scanner disposed in close proximity thereto.

### DETAILED DESCRIPTION

Unless defined otherwise, all technical and scientific terms used herein have the same meaning as commonly understood by one of ordinary skill in the art to which the invention belongs. Although any methods and materials similar or equivalent to those described herein can be used in the practice or testing of the present invention, certain methods and materials are now described.

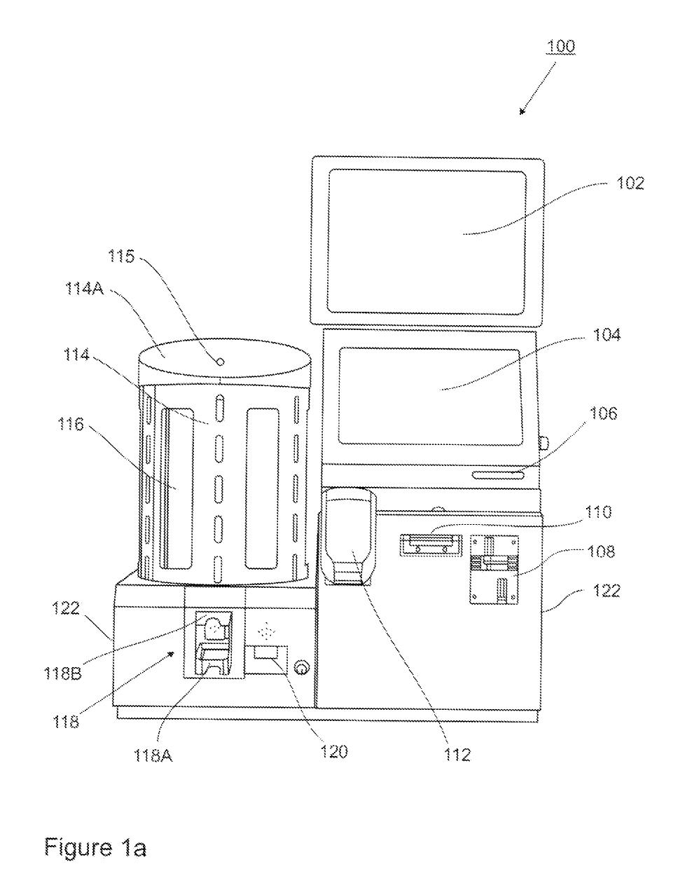

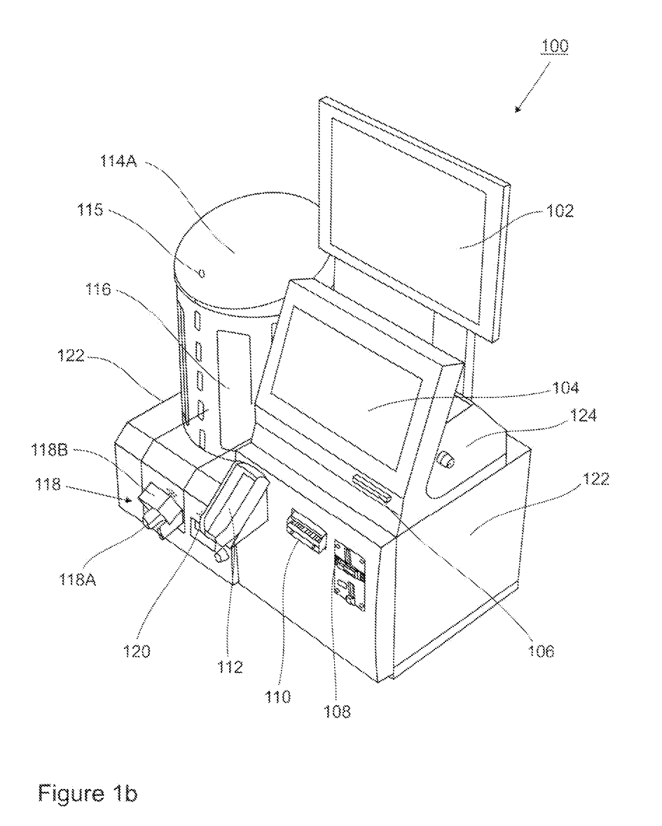

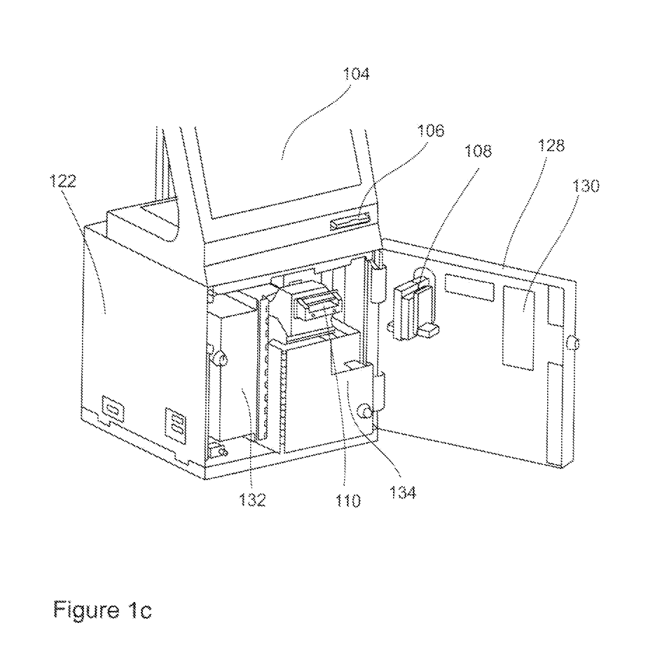

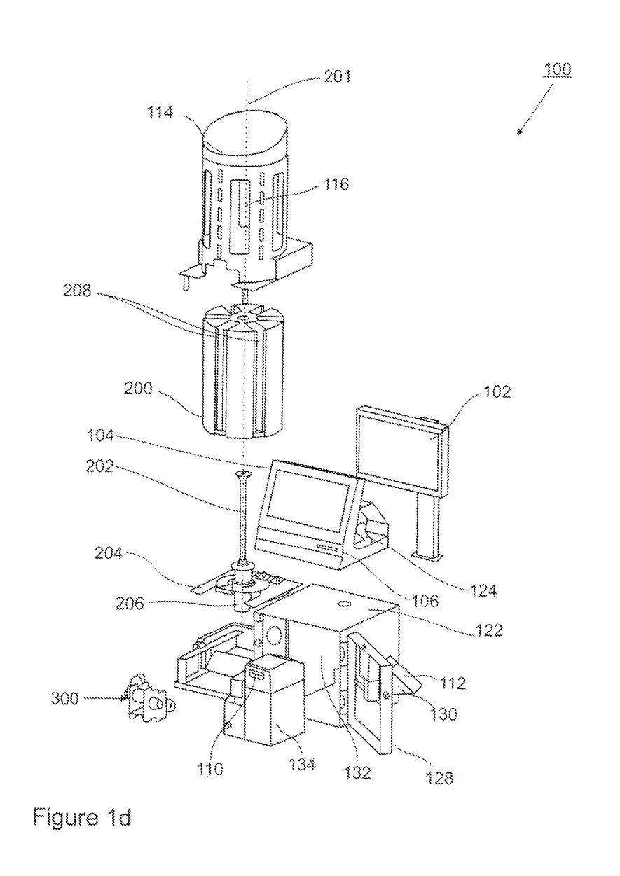

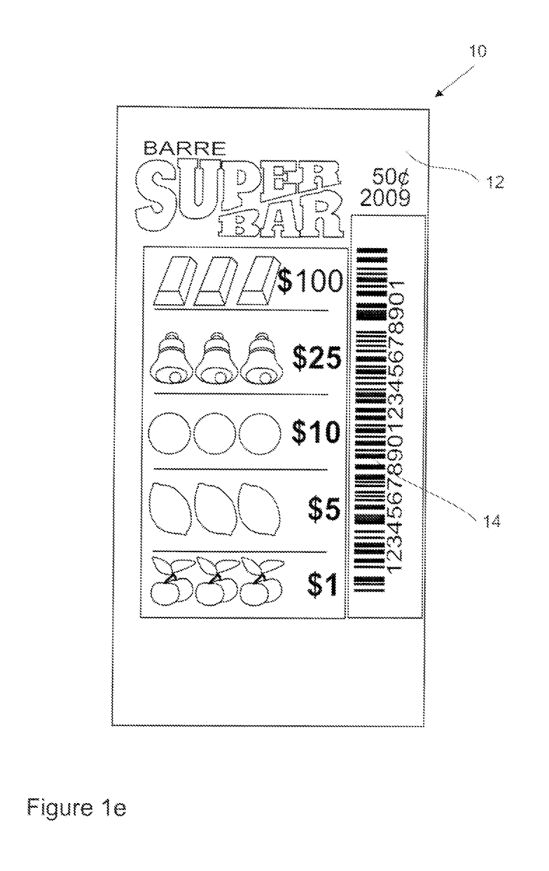

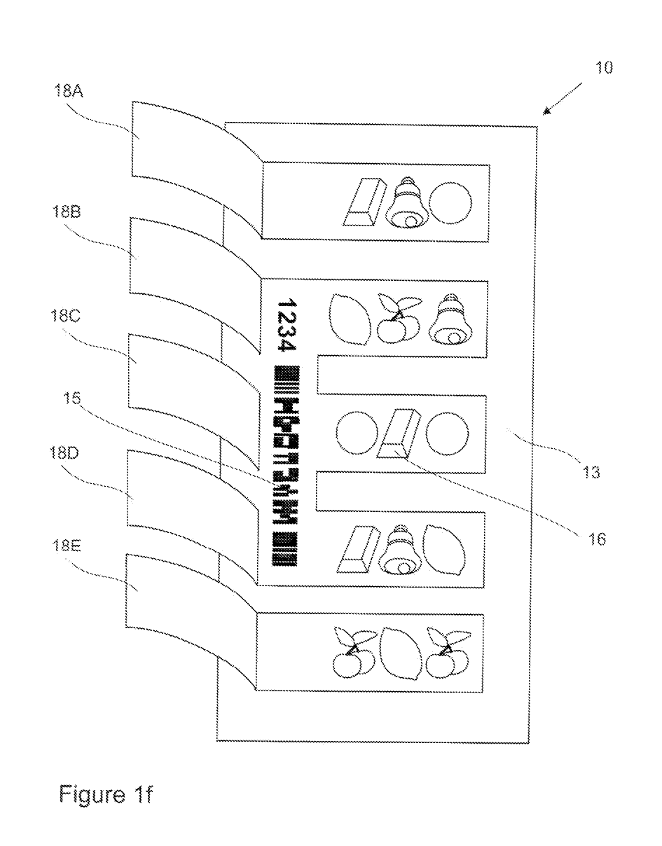

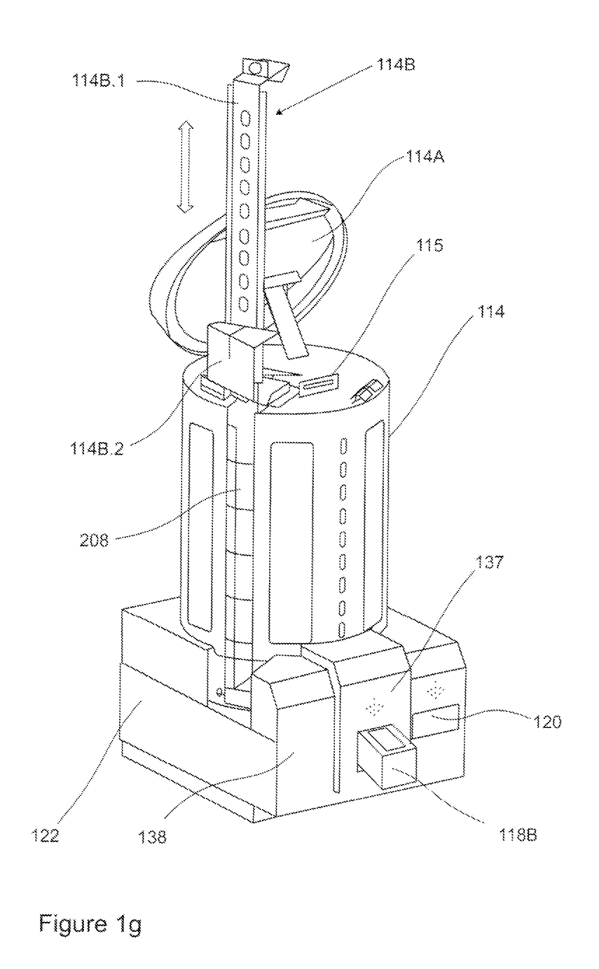

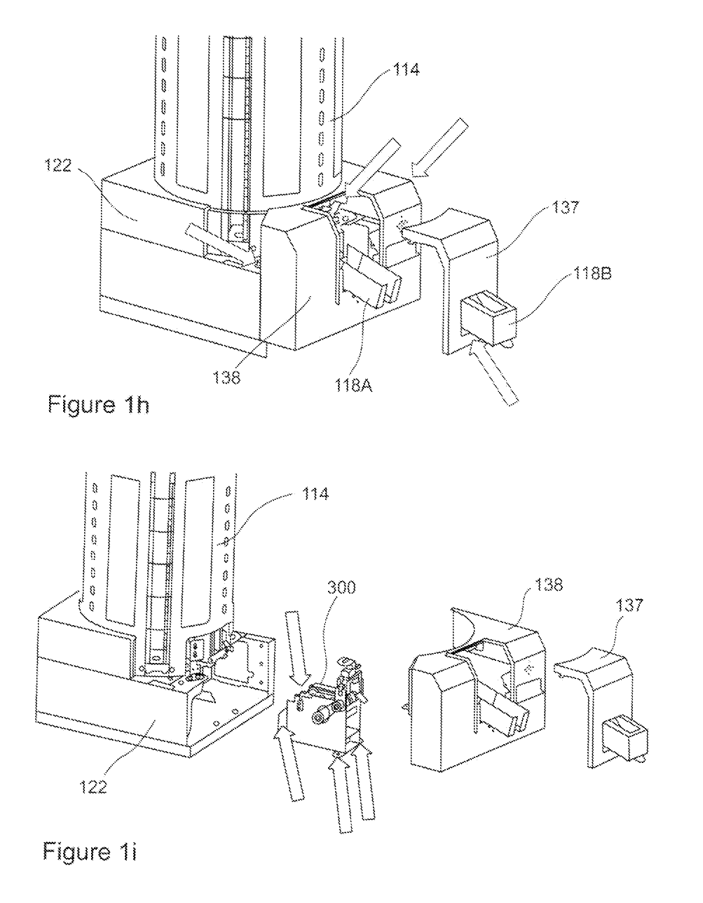

Referring to FIGS. 1a to 1i, an instant lottery ticket vending machine 100 according to one embodiment of the invention is provided. The vending machine 100 comprises various components associated to four main functions thereof: user interaction; payment; control; and, ticket dispensing. User interaction is enabled via user interface 104 such as, for example, an off-the-shelf touch screen connected to computer 132. The user interface 104 enables a player to select purchase of a predetermined number of instant lottery tickets of a particular instant lottery game of a plurality of different instant lottery games. For example, in one case the player selects: 5 tickets of instant lottery game A; 10 tickets of instant lottery game B; and, 3 tickets of instant lottery game C. After selection of the tickets, and in some cases confirmation of the same by the player, the amount for the purchase of the selected tickets is displayed on the user interface 104 together with payment options such as, for example, cash, credit card, or debit card. After selection of the payment option by the player, the corresponding payment device such as, for example, credit/debit card reader 112 or cash collecting device 134 connected to coin module 108 and banknote module 110 are activated and controlled by the computer 132. Optionally, after receipt of the payment a receipt confirming the purchase of the tickets is printed using printer 124 and provided to the player via printer slot 106. The credit/debit card reader 112, the cash collecting device 134, the coin module 108, the banknote module 110 and the printer 124 can be conventional off-the-shelf components.

After receipt of the payment, the computer 132 activates ticket storage unit 200 and ticket dispenser 300 in dependence upon the player's selection for dispensing the tickets 10. For example, the dispensing process can be:

the ticket storage unit 200 is first moved into the corresponding feeding position for dispensing tickets 10 belonging to instant lottery game A;

the ticket dispenser 300 then removes consecutively 5 tickets 10 from ticket storage compartment 208 containing the tickets 10 belonging to instant lottery game A;

the ticket storage unit 200 is then moved into the corresponding feeding position for dispensing tickets belonging to instant lottery game B;

the ticket dispenser 300 then removes consecutively 10 tickets 10 from the ticket storage compartment 208 containing the tickets 10 belonging to instant lottery game B;

the ticket storage unit 200 is moved into the corresponding position for dispensing tickets belonging to instant lottery game C; and

the ticket dispenser 300 then removes consecutively 3 tickets 10 from the ticket storage compartment 208 containing the tickets 10 belonging to instant lottery game C.

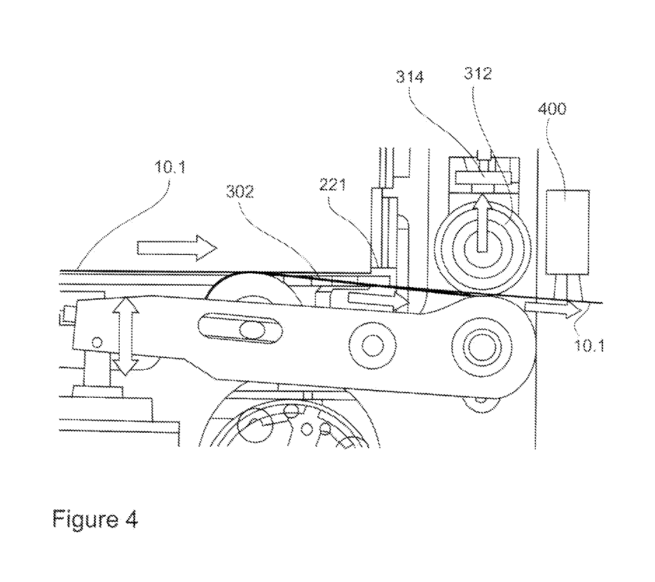

Each ticket can be scanned directly after removal using for example, barcode scanner 400, as illustrated in FIG. 4, for reading ticket identifier 14 disposed on the outside of the ticket 10, and ticket identification data are provided in dependence thereupon to the computer 132 for activating the same, as will be described hereinbelow. The tickets 10 are then dispensed to the player via chute assembly 118. The chute assembly 118 can comprise a ticket collector 118A covered by lid 118B with the lid 118B remaining locked until all tickets 10 purchased by the player are dispensed and collected in the ticket collector 118A. After all the tickets are collected in the ticket collector 118A the lock of the lid 118B is released enabling the player to lift the lid 118B and to remove the tickets 10 from the ticket collector 118A.

A plurality of instant lottery ticket vending machines 100 can be provided with the computer 132 of each instant lottery ticket vending machine 100 being connected to a central data processing unit via a computer network such as, for example, the Internet, forming a linked network of instant lottery ticket vending machines 100. The central data processing unit is placed in a trusted entity such as, for example, an administrative center or headquarters of the lottery operator and comprises, for example, a trusted server computer and a trusted database, while communication with the instant lottery ticket vending machines 100 is performed in a secure manner using state of the art encryption technology. Communication between the trusted server computer and the computer 132 of the instant lottery ticket vending machines 100 is provided, for example, according to a standard communication protocol such as, for example, the Hypertext Transfer Protocol (HTTP).

FIGS. 1e and 1f illustrate a lottery ticket 10 for use with the instant lottery ticket vending machine 100. The lottery ticket 10 comprises a sheet type body such as, for example, a semi-rigid sheet of paper, cardboard, or boxboard. The ticket activation identifier 14 is printed on the front 12 of the ticket 10 in the form of, for example, a linear barcode, or a matrix barcode. The ticket activation identifier can be uniquely related to the lottery ticket such that each lottery ticket of the plurality of lottery tickets has a unique identifier with ticket identifier data indicative thereof being stored in the trusted database. The lottery ticket 10 further comprises play area 16 disposed on the back 13 of the ticket 10 in a concealed fashion together with the prize identifier 15 which is provided in the form of, for example, a linear barcode, or a matrix barcode. Optionally, at least a portion of the identifiers 14 and 15 is encoded using, for example, an error correcting code such as a Reed Salomon code to provide an indication that the identifier has been corrupted and/or to retrieve the identifier in case the barcode has been damaged. The play area 16 and the prize identifier 15 are revealed by the player opening break-open tabs 18A to 18E.

After revealing the prize identifier 15 the player holds the opened ticket 10 under scanner 120 for example, a barcode scanner, for reading the prize identifier 15 and providing prize data in dependence thereupon to the trusted server computer via computer 132. In case of a network of a plurality of connected instant lottery ticket vending machines 100 the player is able to use the scanner 120 of any of the instant lottery ticket vending machines 100 of the network. In case the prize identifier 15 is uniquely related to the lottery ticket such that each lottery ticket of the plurality of lottery tickets has a unique prize identifier 15 the trusted server computer is able to identify the lottery ticket for determining the prize. In case the prize identifier 15 is only indicative of the prize, the player first holds the ticket 10 under the scanner 120 for reading the ticket activation identifier 14 and then for reading the prize identifier 15. The trusted server computer then determines the prize and provides data indicative of the prize to the computer 132 for displaying the same to the player using, for example, the touch screen 104. A prize receipt confirming the prize is printed using printer 124 and provided to the player via printer slot 106 for redemption of the prize, for example, at a lottery ticket retailer.

Provision of a network of a plurality of connected instant lottery ticket vending machines 100 enables implementation of an instant lottery game having varying prizes such as, for example, a progressive jackpot pool. The varying prizes are displayed using display 102, for example, an off-the-shelf flat screen monitor, connected to the computer 132.

Furthermore, an instant lottery game may be implemented where a winning ticket has one of a plurality of different prizes—for example, $100, $500, $1000, $2500—with the prize being determined, for example, in a random or pseudo-random fashion, by the trusted server computer and displayed on the touch screen 124.

Various sensitive components of the instant lottery ticket vending machine 100—such as, for example, the computer 132, the cash collecting device 134, the coin module 108, the banknote module 110, the ticket dispenser 300, and, the reader for reading the ticket identifier for activation—are, in one case, housed in a substantially secure and tamper resistant housing 114, 122 that enables access via movable covers 114A, 128, 137, and 138 only to authorized personnel—for example, for maintenance—using, for example, a secure locking mechanism known in the art. Optionally, opening of the housing 122 is controlled by the trusted server computer, for example, a message is sent to the trusted server computer when the covers 128, 138 are opened. The printer 124 can be placed outside the secure housing 122 to enable un-authorized personnel maintenance thereof, for example, refilling the printing paper. The credit/debit card reader 112 can be mounted in a substantially secure and tamper resistant fashion, for example, via holder 130 to the cover 128 while the coin module 108 comprises a bezel and is mounted to the inside of the cover 128.

The ticket storage unit 200 can comprise a plurality of ticket storage compartments 208 for storing tickets 10 associated with different instant lottery games and is provided in the form of a ticket storage carousel 200 which is rotatable movable about substantially vertically oriented axis 201, enabling employment of a single stationary ticket dispenser 300. The ticket storage carousel 200 is mounted to shaft 202, rotated by drive mechanism 206 which is mounted to the housing 122 via support plate 204. Using the drive mechanism 206, the carousel 200 is rotated such that the respective compartment 208 containing the tickets 10 associated with the instant lottery game selected by the player is placed to the feeding position enabling the stationary ticket dispenser 300 to retrieve the tickets 10 from the compartment 208, as will be described hereinbelow. Cylindrical cover 114 surrounds the carousel 200 and, in one case, comprises openings 116 coinciding with display panels disposed on the carousel when positioned for dispensing tickets. The cylindrical cover 114 can be fastened to the housing 122 in a substantially secure and tamper resistant fashion and comprises a hinged top cover 114A which is secured via lock 115 such as, for example, a key lock. Alternatively, the ticket storage unit 200 is linearly movable for placing a compartment 208 containing the tickets 10 associated with the instant lottery game selected by the player to the feeding position.

The ticket storage compartments 208 are accessed, for example, for refilling the same, by opening the hinged top cover 114A and pulling ticket access cover 114B, as indicated by the block arrow in FIG. 1g. Ticket access cover 114B comprises an upper portion 114B.1 and a lower portion 114B.2 with the upper portion 114B.1 interfacing snugly with the cover 114 and the lower portion 114B.2 interfacing snugly with the housing 122, for example, by interfacing the same in respective grooves or slots, such that the ticket access cover 114B can easily be removed/inserted in a vertical direction as indicated by the block arrow in FIG. 1g.

Referring to FIG. 1h, cover 137 is removable mounted to the cover 138 in a substantially secure and tamper resistant fashion, for example, by abutting the top and fastening the bottom using a tamper resistant Torx screw fastener, indicated by the block arrow. After removal of the ticket access cover 114B and the cover 137, screws—indicated by block arrows—fastening the cover 138 to the housing 122 can be accessed for removing the cover 138. After unplugging the wire-harness connecting the reader 120 to the computer 132, the cover 138—having the reader 120 mounted thereto—can be removed, giving access to the ticket dispenser 300, as illustrated in FIG. 1i. The ticket dispenser 300 is removable mounted to the housing 122 at the back and the front bottom—indicated by block arrows—using screw fasteners. Removal of the ticket dispenser 300 after unplugging the wire-harness connecting the same to the computer 132 enables access to the drive and control mechanism of the carousel 200.

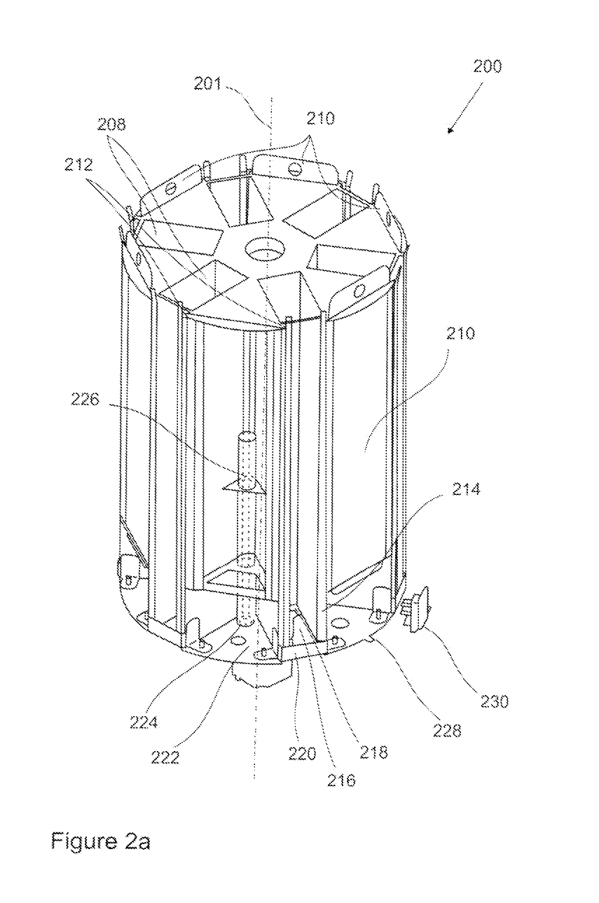

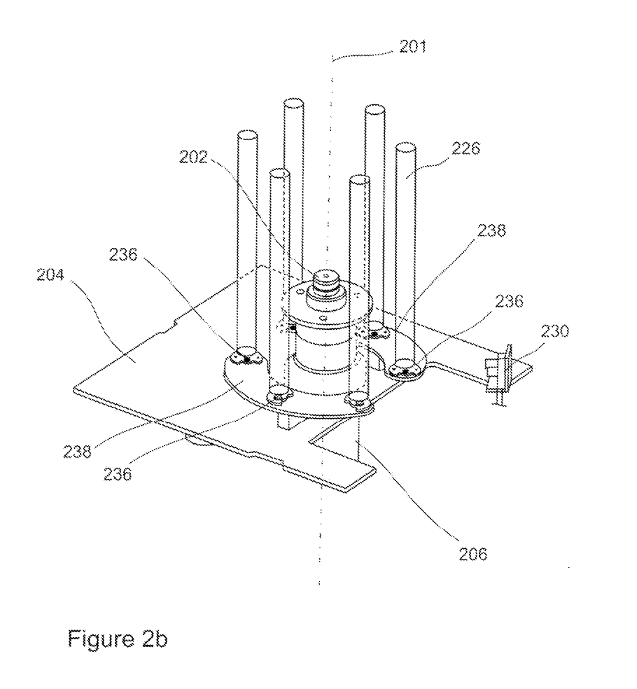

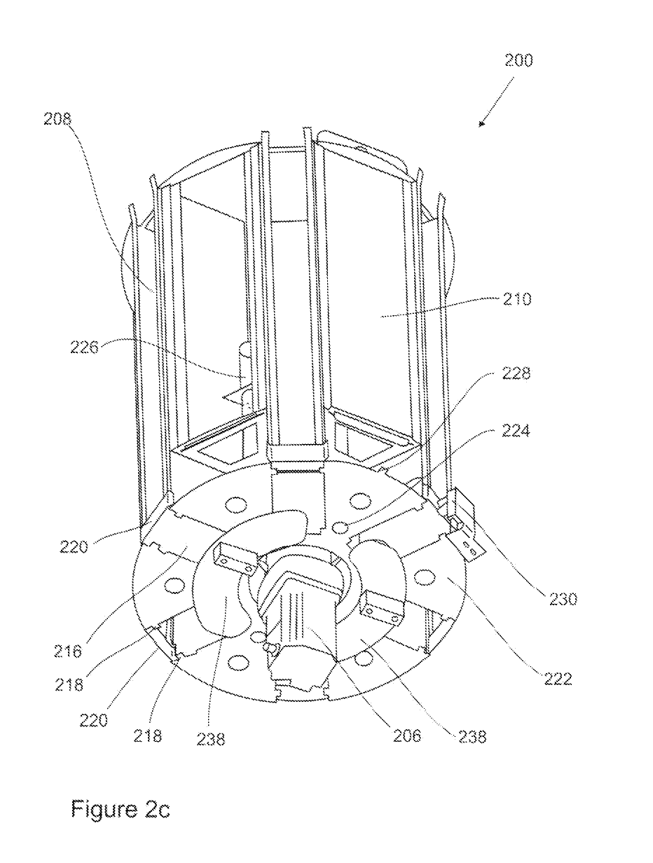

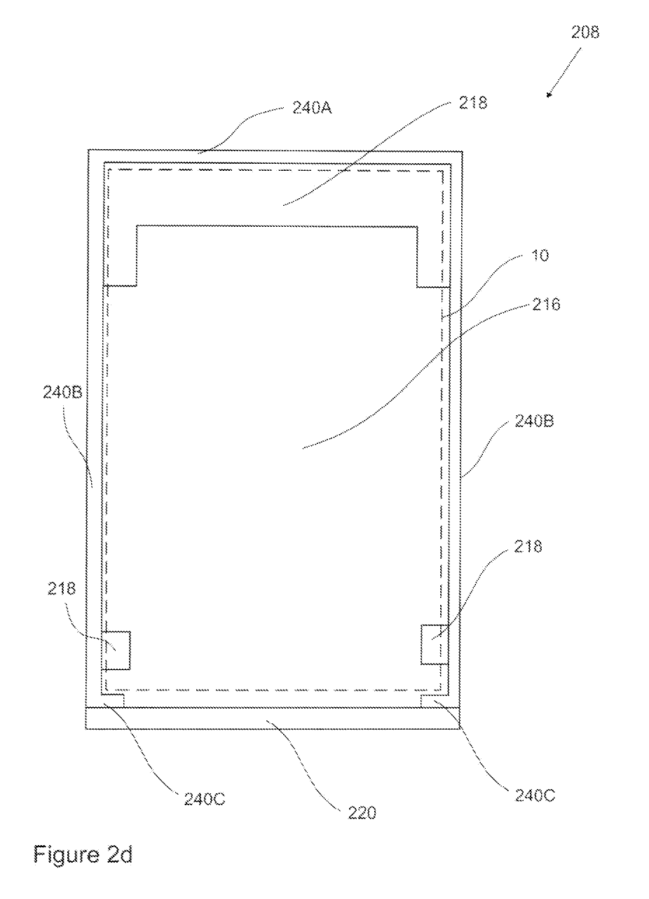

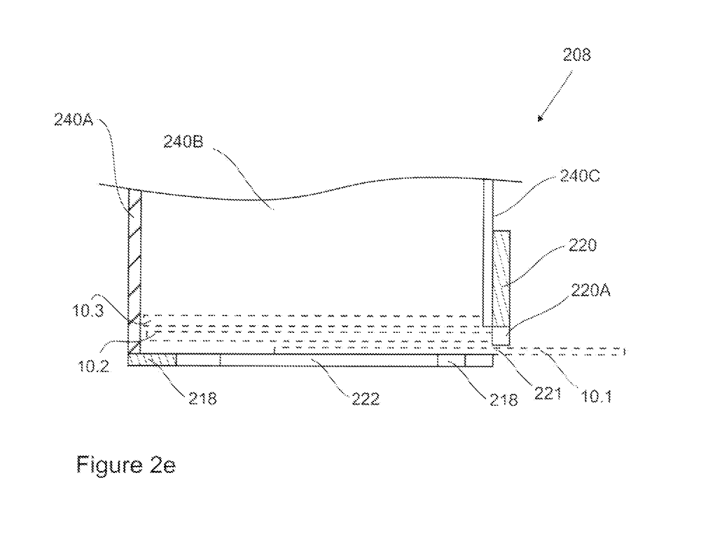

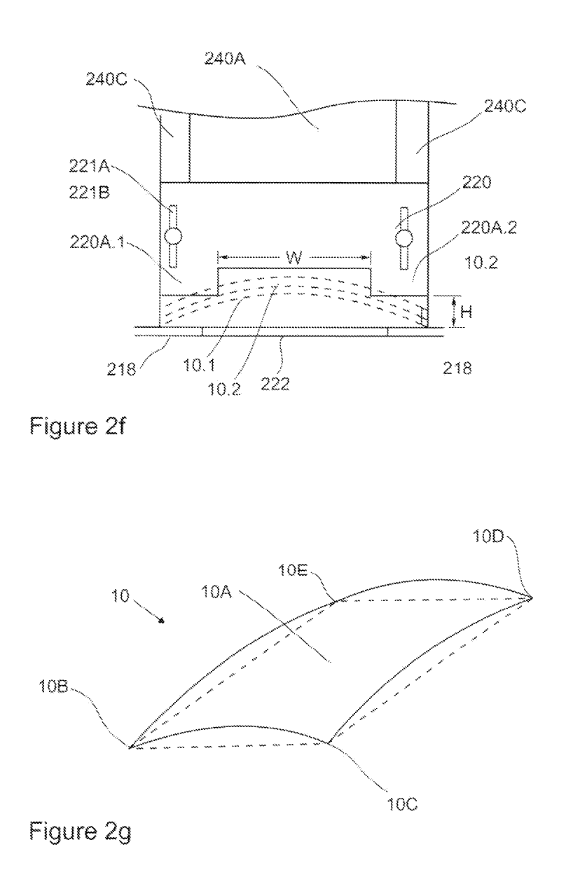

FIGS. 2a to 2f illustrate the ticket storage carousel 200 according to one embodiment of the invention. The ticket storage carousel 200 comprises a plurality of ticket storage compartments 208 for storing loose tickets 10 therein such that the tickets 10 are oriented substantially horizontally and stacked upon each other substantially vertically. Each storage compartment comprises a bottom holding structure 218 which interacts with a portion of a bottom surface of a bottom ticket 10.1 for holding the bottom ticket 10.1 and the tickets 10.2, 10.3, . . . stacked thereupon, in one case, such that the tickets 10 are oriented substantially horizontally. Back-wall 240A, side-walls 240B, and front-edges 240C hold the stack of tickets 10 in a substantially vertical direction. As is evident to one skilled in the art, there are various possibilities for holding the stack of tickets 10, such as, for example, four substantially vertical oriented corner edges placed in proximity to the corners of the tickets 10, or substantially vertical oriented rods surrounding the stack of tickets 10. Optionally, the storage compartments 208 are adjustable for containing differently sized tickets 10, for example, when refilled with tickets 10 associated with a different instant lottery game. The bottom holding structure 218 can be provided as part of a bottom plate 222 of the carousel having openings 216 disposed therein. Gate extensions 220A.1, 220A.2 of front plate 220 form gate 221 in concert with bottom holding structure 218 for transmitting the bottom ticket 10.1 therethrough while substantially preventing transmission of ticket 10.2 stacked upon the bottom ticket 10.1, as illustrated in FIGS. 2e and 2f.

Typically, break-open lottery tickets 10 tend to curve from the center 10A towards the corners 10B-10E, as illustrated in FIG. 2g, resulting in a highly unreliable dispensing process using standard ticket dispensers. This problem is overcome by providing the front plate 220 with left and right gate extensions 220A.1, 220A.2, respectively, for preventing transmission of ticket 10.2 stacked upon the bottom ticket 10.1. The recess of width W between the gate extensions 220A.1, 220A.2 enables reliable transmission of ticket 10.1 when curved, as illustrated in FIG. 2f, as well as when flat. It is noted that break-open lottery tickets tend to curve to one side and can, therefore, all be stacked such that they are curved downwardly towards the corners 10B-10E as illustrated in FIGS. 2f and 2g.

The front plate 220 can be vertically adjustable mounted to the storage compartment 208 using, for example, conventional screw fasteners 221B in concert with elongated apertures 221A disposed in the front plate 220, enabling calibration of the height H between the bottom edge of the gate extensions 220A.1, 220A.2 and bottom holding structure 218 to the thickness and curvature of the tickets 10 as well as adjustment for dispensing tickets 10 having different thickness. Optionally, the gate extension 220A is omitted and the bottom edge of the front plate 220 forms the gate 221 in concert with bottom holding structure 218.

The ticket storage carousel 200 is rotated using the drive mechanism 206, such as an off-the-shelf stepper drive mechanism, which is controlled by the computer 132 connected thereto. Correct placement of the respective compartment 208 containing the tickets 10 associated with the instant lottery game selected by the player to the feeding position is enabled using Hall Effect sensor 230, such as an off-the-shelf Hall Effect sensor, mounted to the support plate 204 in concert with positioning protrusion 228 protruding from the bottom plate 222 of the ticket storage carousel 200 at a predetermined position on the circumference thereof. The Hall Effect sensor 230 provides a positioning signal to the computer 132 every time the positioning protrusion 228 passes the same. Using the computer 132 the drive mechanism 206 is controlled in dependence upon the ticket selection of the player and the positioning signal of the Hall Effect sensor 230. For example, after receipt of the payment the computer determines the respective compartment 208 containing the tickets 10 associated with the instant lottery game selected by the player and its position with respect to the positioning protrusion 228. The ticket storage carousel 200 is then rotated until a Hall Effect sensor signal is received followed by the further rotation of the angular distance between the positioning protrusion 228 and the position of the respective compartment 208. Alternatively, a different technology for sensing the position of the ticket storage carousel 200 is employed such as, for example, sensing a laser beam using a photodiode with the laser beam being interrupted by the positioning protrusion 228.

The ticket storage carousel 200 can comprise translucent display panels 210 placed between adjacent ticket storage compartments 208. The display panels 210 are illuminated using light pipes 226 disposed therebehind above openings 224 disposed in the bottom plate 222 of the ticket storage carousel 200. The light pipes 226 receive light from respective light sources such as, for example, high intensity LEDs 236, mounted to the support plate 204 via LED support structure 238, when the ticket storage carousel 200 is positioned such that one of the ticket storage compartments 208 is in the feeding position. The light pipes 226 are, for example, solid transparent cylinders made of acrylic glass. The display panels 210 are made of, for example, acrylic glass sheets which are removable inserted into slots 212, enabling simple exchange of the same, for example, when advertising a different instant lottery game. The LEDs can be off-the-shelf LEDs.

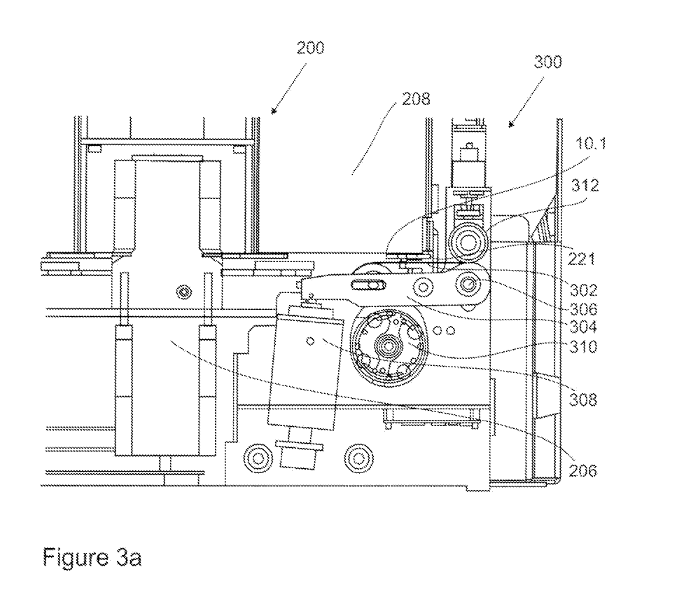

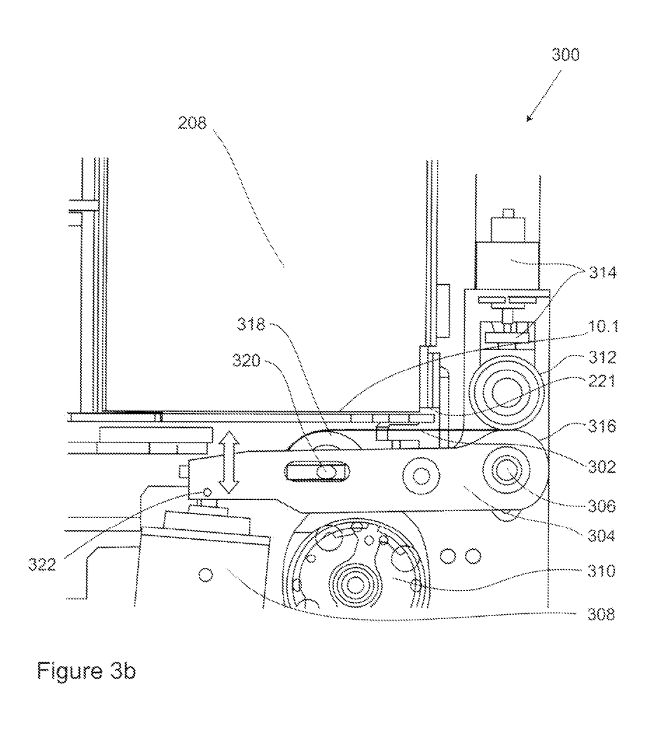

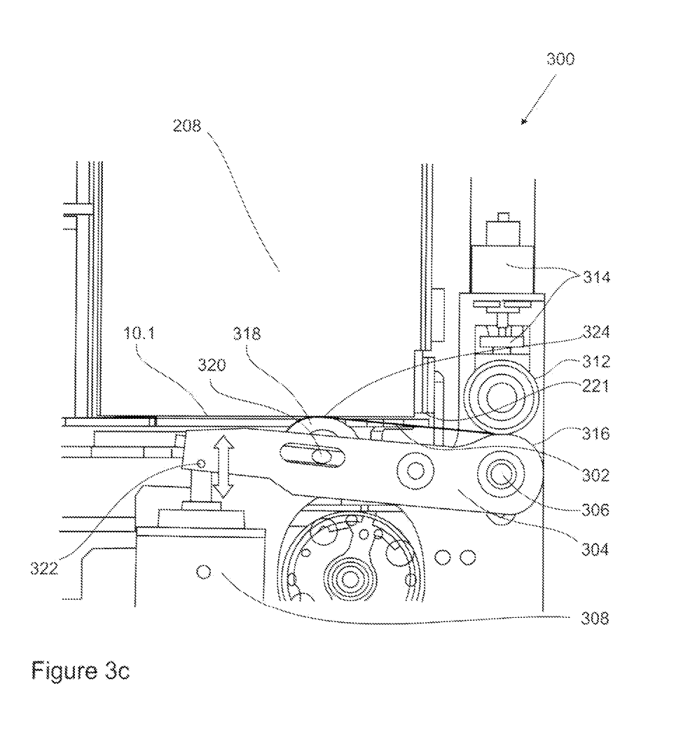

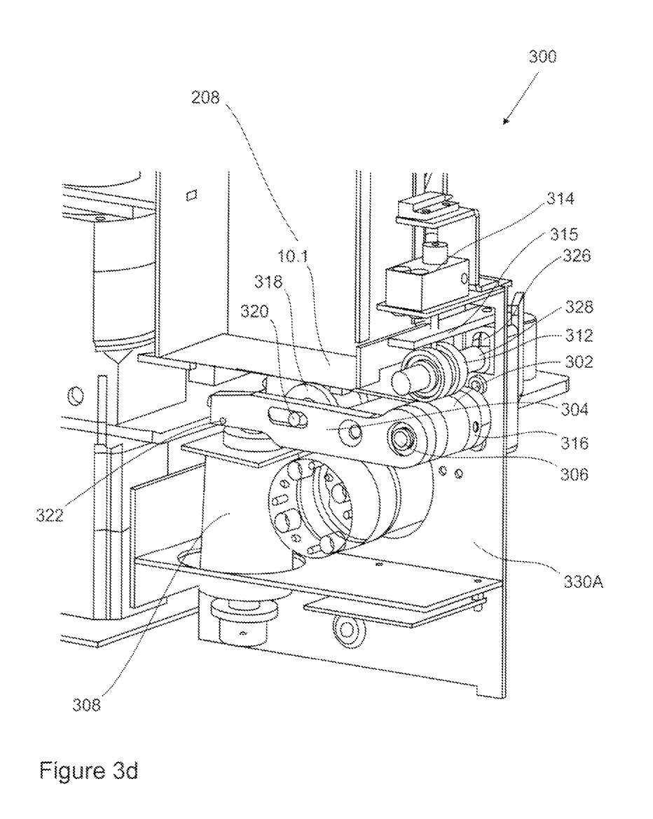

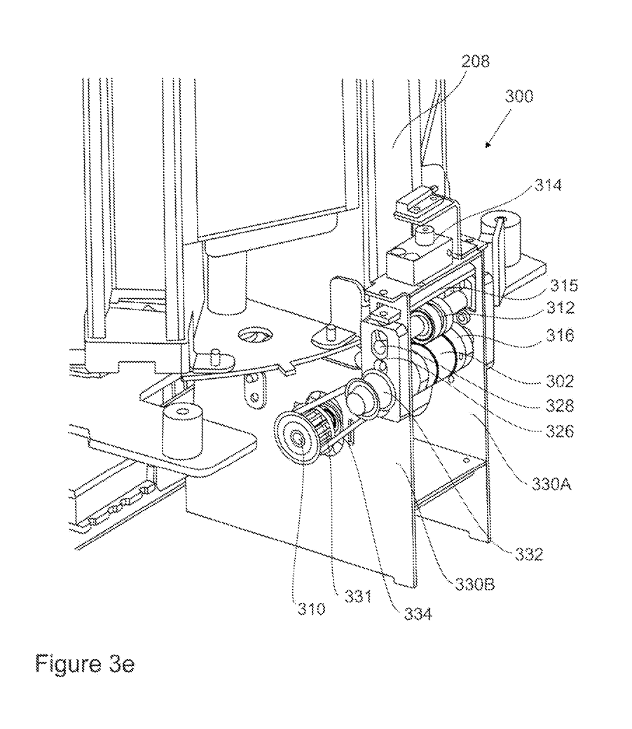

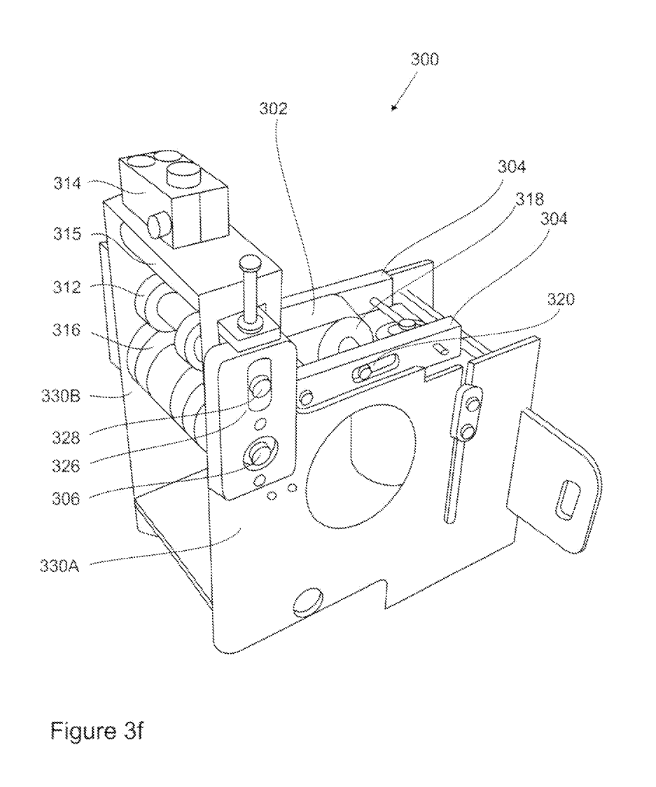

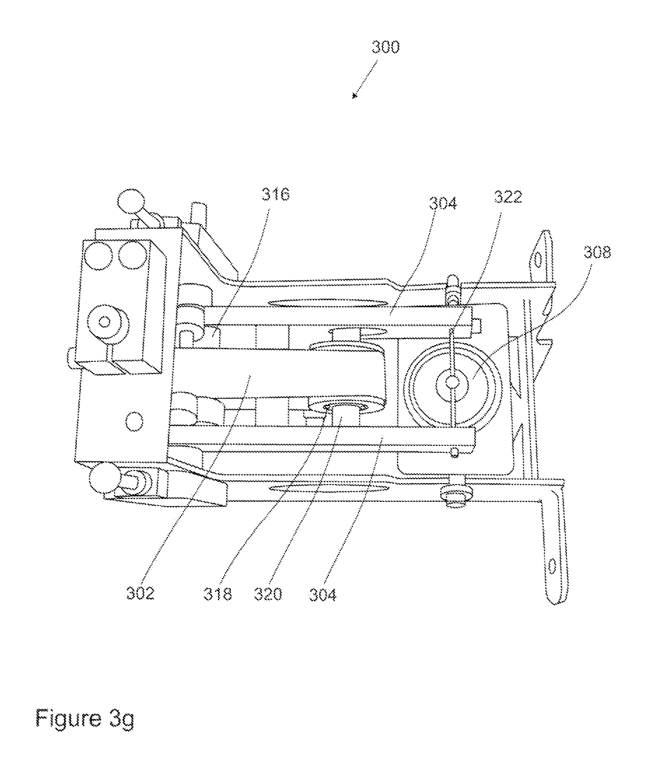

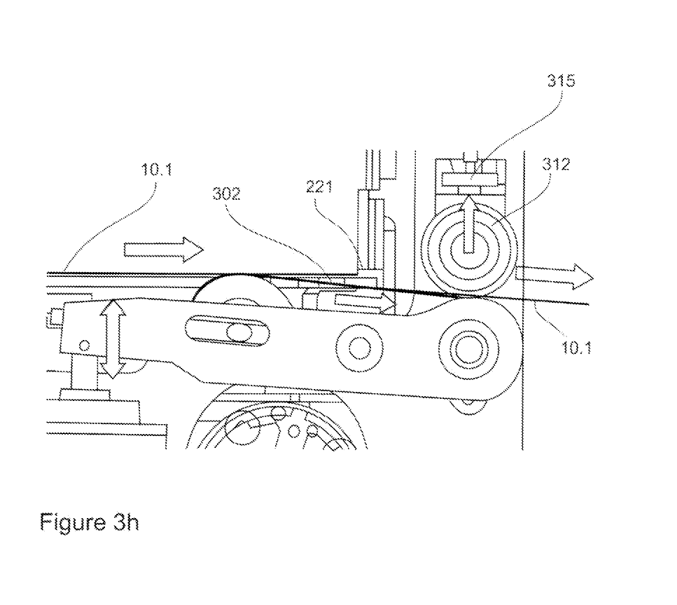

FIGS. 3a to 3h illustrate the ticket dispenser 300 according to one embodiment of the invention. The ticket dispenser 300 comprises a conveyor for conveying the bottom ticket 10.1 by interacting with a portion of the bottom surface thereof through the carousel opening 216 of the respective ticket storage compartment 208 in the feeding position. The ticket conveyor comprises a conveying belt 302 rotatable about a first pulley 316 and a second pulley 318. The second pulley 318 is rotatable mounted to conveyor arm 304 via axle 320. The conveyor arm 304 is pivotably movable about axle 306 of the first pulley 316 with the axle 306 being rotatable mounted to dispenser housing plates 330A and 330B. The conveyor arm 304 and the axles 306 and 320 are rotatable mounted in a conventional manner such as, for example, a cylindrical axle accommodated in a respective bore or using a bearing. The conveying belt 302 is driven by driving the axle 306 of the first pulley 316 via drive mechanism 310, pulleys 331 and 332, and belt 334 such as, for example, a conventional V-belt or toothed belt, enabling driving the conveying belt 302 while the conveyor arm 304 is moved about the axle 306. Actuator 308 such as, for example, a conventional Linear Push Solenoid, is pivotally movable connected to the conveyor arm 304 at pivot 322 opposite the axle 306 for moving the conveyor arm between an up position and a down position, as indicated by the block arrow in FIGS. 3b and 3c. In the up position, a portion of the conveyor belt 302 is interacting with a portion of the bottom surface of the bottom ticket 10.1 at contact 324 for conveying the bottom ticket 10.1 through the gate 221 towards vertically movable pinch wheel 312. The surface of the conveyor belt 302 is made of a material having sufficient grip when in contact with the bottom surface of the bottom ticket 10.1 such as, for example, a rubber material. Moving the conveyor arm 304 between an up position and a down position enables conveyance of the tickets 10 in quick succession by keeping the conveying belt 302 rotating while the conveyor arm 304 is quickly moved into the up position for conveying the bottom ticket 10.1 and then moved from the up position into the down position, for example, when the conveyed bottom ticket 10.1 has reached the contact of the pinch wheel 312 with the conveying belt 302. After the bottom ticket 10.1 is moved under the pinch wheel 312, the conveyor arm 304 is quickly moved into the up position again for conveying the following bottom ticket 10.1 from the ticket storage compartment 208. The up position of the conveyor arm 304 and/or the position of the contact 324 of the conveying belt 302 can be adjustable, for example, by adjusting the connection of the actuator 308 with the conveyor arm 304 and/or the placement of the axle 320 along the conveyor arm 304, enabling calibration of the dispenser 300 in concert with the adjustment of the gate 221 to substantially reduce the likelihood of mis-feeds and double-feeds.

Axle 328 of pinch wheel 312 is pivotally movable as well as vertically linearly movable mounted to the dispenser housing plates 330A and 330B. For example, axle 328 is linearly movable accommodated in vertically oriented slots 326 disposed in the dispenser housing plates 330A and 330B. The pinch wheel 312 can have an axis of rotation oriented substantially parallel to the axis of rotation of the first pulley 316 and is linearly movable mounted such that its axis of rotation is linearly movable in a substantially vertical oriented plane through the axis of rotation of the first pulley 316. The vertical displacement of the pinch wheel 312 can be sensed in a conventional manner using, for example, an off-the-shelf Linear Voltage Displacement Transducer (LVDT) 314 and rocker arm 315. As the ticket 10.1 is conveyed under the pinch wheel 312 the same is moved upward, as indicated by the block arrows in FIG. 3h, and deflects the rocker arm 315 which is then measured by the LVDT 314. The LVDT provides a signal indicative of the vertical movement of the pinch wheel 312 to the computer 132. The LVDT signal is then processed by the computer for controlling the up and down movement of the conveyor arm 304. For example, when the LVDT signal is indicative of the pinch wheel 312 being moved up by the ticket 10.1 the conveyor arm 304 is moved down and when the LVDT signal is indicative of the pinch wheel 312 being moved down after the ticket 10.1 has passed the conveyor arm 304 is moved up.

Furthermore, the LVDT signal is processed by the computer for mis-feed detection and double-feed detection. Depending on the vertical displacement of the pinch wheel 312 the LVDT signal is indicative of: no ticket; one ticket; or, more than one ticket, with no ticket—LVDT signal is not indicative of a leading and trailing edge of the ticket—indicating mis-feed and more than one ticket—LVDT signal is indicative of a displacement of the pinch wheel 312 larger than the thickness of one ticket—indicating double feed. In case mis-feed or double-feed is detected, the computer 132 stops the dispensing of the tickets and sends a control signal to the trusted server computer requesting an attendant.

Referring to FIG. 4, the scanner 400 such as, for example, a conventional high speed barcode scanner is disposed in proximity to the dispenser 300 for reading the ticket activation identifier 14 printed on the front 12 of the ticket 10 as soon as the ticket 10 is conveyed through the dispenser 300. The scanner 400 then provides ticket identification data in dependence thereupon to the computer 132 which are then transmitted to the trusted server computer for activating the same.

Each ticket 10 has its unique ticket activation identifier 14 printed thereon with corresponding ticket identifier data being stored in the trusted data together with activation data indicative of the activation state of the ticket 10, either being in an inactive/unpurchased state or an active/purchased state. Initially the activation data of each ticket 10 are indicative of the inactive/unpurchased state. After receipt of the data from the scanner 400 the trusted server computer generates activation data indicative of the ticket being in an active/purchased state and stores the same together with the data indicative of the ticket 10.

Provision of the scanner 400 for reading the ticket activation identifier 14 enables differentiation between properly purchased tickets 10 and stolen tickets 10, preventing illicit redemption of a price. Upon receipt of the prize data, the trusted server computer retrieves the activation data associated with the ticket 10 and determines the prize if the activation data are indicative of the ticket 10 being in the active/purchased state. If the activation data are indicative of the ticket 10 being in the inactive/unpurchased state the trusted server computer does not determine the prize and, for example, generates a warning message indicative of a stolen ticket 10.

The present invention has been described herein with regard to certain embodiments. However, it will be obvious to persons skilled in the art that a number of variations and modifications can be made without departing from the scope of the invention as described herein.

What is claimed is:

1. A ticket dispenser comprising:
a ticket storage container for storing loose tickets therein such that the tickets are oriented substantially horizontally and stacked upon each other substantially vertically, the ticket storage container having a holding structure for interacting with a portion of a bottom surface of a bottom ticket and a gate for transmitting the bottom ticket therethrough while substantially preventing transmission of a ticket stacked upon the bottom ticket;
a ticket conveyor for conveying the bottom ticket by interacting with a portion of the bottom surface thereof; and
a controller connected to the ticket conveyor for controlling operation of the ticket conveyor such that the tickets are successively transmitted.

2. The ticket dispenser according to claim 1 comprising an actuator connected to the ticket conveyor and the controller for moving the ticket conveyor between an up position and a down position, wherein in the up position a portion of the conveyor is interacting with the portion of the bottom surface of the bottom ticket.

3. The ticket dispenser according to claim 1 comprising a sensing device for sensing the presence of a ticket and providing a signal indicative of: no ticket; one ticket; or, more than one ticket.

4. The ticket dispenser according to claim 3 wherein the sensing device comprises a substantially vertical movable sensing wheel and a sensor for sensing vertical movement of the sensing wheel.

5. The ticket dispenser according to claim 1 wherein the ticket conveyor comprises a conveying belt rotatable about a first and a second pulley, the second pulley being rotatable mounted to a conveyor arm with the conveyor arm being pivotable movable mounted about an axis of rotation of the first pulley.

6. The ticket dispenser according to claim 5 comprising an actuator connected to the conveyor arm and the controller for moving the conveyor arm between an up position and a down position, wherein in the up position a portion of the conveying belt is interacting with the portion of the bottom surface of the bottom ticket.

7. The ticket dispenser according to claim 6 comprising:
a substantially vertically movable sensing wheel having an axis of rotation oriented substantially parallel to an axis of rotation of the first pulley, the sensing wheel being linearly movable mounted such that its axis of rotation is linearly movable in a substantially vertical oriented plane through the axis of rotation of the first pulley; and
a sensor for sensing vertical movement of the sensing wheel and providing a signal indicative of: no ticket; one ticket; or, more than one ticket.

8. The ticket dispenser according to claim 1 comprising:
a carousel having a plurality of ticket storage containers, the carousel being rotatable about a substantially vertical oriented axis of rotation; and
a drive mechanism connected to the carousel and the controller for rotating the carousel in dependence upon a carousel control signal received from the controller such that a predetermined ticket storage container is placed at a predetermined location for enabling the ticket conveyor to convey the bottom ticket disposed therein.

9. The ticket dispenser according to claim 8 wherein the drive mechanism comprises a stepper motor.

10. The ticket dispenser according to claim 9 comprising a Hall Effect sensor connected to the controller for controlling the stepper motor.

11. The ticket dispenser according to claim 8 wherein the carousel comprises:
a translucent display panel placed between adjacent ticket storage containers; and
a light pipe disposed between adjacent ticket storage containers for receiving light from at least a light source disposed outside the carousel when the predetermined ticket storage container is placed at the predetermined location and for providing the light for illuminating at least one of the translucent display panels.

12. The ticket dispenser according to claim 1 wherein the gate comprises:
a left and a right gate extension for preventing transmission of the ticket stacked upon the bottom ticket; and
a recess between the left and the right gate extension for enabling transmission of the bottom ticket when curved.

13. A lottery ticket vending machine comprising:
a user interface for being operated by a player, the user interface being adapted for enabling user interaction for purchasing a lottery ticket;
a controller connected to the user interface for controlling operation of the lottery ticket vending machine;
a ticket storage container for storing loose tickets therein such that the tickets are oriented substantially horizontally and stacked upon each other substantially vertically, the ticket storage container having a holding structure for interacting with a portion of a bottom surface of a ticket placed at a bottom of the stack and a gate for transmitting the ticket therethrough while substantially preventing transmission of a ticket stacked thereupon;
a ticket conveyor connected to the controller, the ticket conveyor for conveying the ticket by interacting with a portion of the bottom surface thereof;
a dispensing chute for receiving the ticket from the ticket conveyor and dispensing the same to the player; and
a reader connected to the controller, the reader being disposed between the ticket conveyor and the dispensing chute for reading a ticket identifier disposed on the ticket after removal from the ticket storage container and prior provision to the dispensing chute and for providing ticket identification data in dependence thereupon to the controller.

14. The lottery ticket vending machine according to claim 13 comprising:
a carousel having a plurality of ticket storage containers, the carousel being rotatable about a substantially vertical oriented axis of rotation; and
a drive mechanism connected to the carousel and the controller for rotating the carousel in dependence upon a carousel control signal received from the controller such that a predetermined ticket storage container is placed at a predetermined location for enabling the ticket conveyor to convey the ticket placed at the bottom of the stack disposed therein.

15. The lottery ticket vending machine according to claim 13 comprising a prize reader connected to the controller, the prize reader for reading a prize identifier disposed on the ticket in a at least partially concealed fashion and revealed by the player and for providing prize data in dependence thereupon to the controller.
